(19) United States
(12) Patent Application Publication
(10) Pub. No.: US 2008/0190550 A1
(43) Pub. Date: Aug. 14, 2008

(54) Method and Apparatus That Can Be Used in the Automated Construction of a Vehicle Tire

(75) Inventors: Markus Groppe, Hannover (DE); Jens Winkler, Hannover (DE)

Correspondence Address: LERNER GREENBERG STEMER LLP, P O BOX 2480, HOLLYWOOD, FL, 33022-2480, US

(73) Assignee: CONTINENTAL AKTIENGESELLSCHAFT, Hannover (DE)

(21) Appl. No.: 11/915,068

(22) PCT Filed: Apr. 1, 2006
(86) PCT No.: PCT/EP2006/002991

§ 371 Date: Nov. 20, 2007

(30) Foreign Application Priority Data
May 24, 2005 (DE) DE102005023925.0

(51) Int. Cl. B29D 30/08

(52) U.S. Cl. 156/117; 156/397

(57) ABSTRACT

A method that can be used in the automated construction of a vehicle tire, using butt spliced tire components consisting of material webs, for example textile cords or steel cords that are embedded in a rubber mixture, to produce a carcass insert of the vehicle tire. The end sections of the cut material web can be clamped in a splicing device with pairs of upper and lower splicing elements, which can be displaced in relation to one another and the sections can be butt spliced. One end section of the cut material web is laid and fixed on one splicing element of the pair of splicing elements and a base part that supports the pair of splicing elements is rotated through 360°, during the feeding of the material web, until the second end section of the looped material web is positioned and fixed in the vicinity of the first end section and on the same plane as the latter on the second splicing element of the pair of splicing elements and finally the sections are joined in a butt splice by the horizontal displacement of the pair of upper and lower splicing elements towards one another.

The invention relates to a method and an apparatus that can be used in the automated construction of a pneumatic vehicle tyre, using butt spliced tyre components consisting of material webs, for example textile cords or steel cords that are embedded in a rubber mixture, to produce a carcass insert of the vehicle tyre, it being possible for the end sections of the cut-to-length material web to be clamped in a splicing device comprising pairs of upper and lower splicing elements that can be moved in relation to one another and for said sections to be joined together with a spliced joint.

Splicing installations that allow butt splicing of the two end sections of a material web, for example to produce an annularly preformed steel or textile cord carcass for car or truck tyres, are known in various embodiments from the patent literature. Steel or textile cord carcass inserts are usually produced from rubber-coated cord webs, divided into sections 500 mm to 1500 mm wide and end sections thereof are joined to one another with a spliced joint. In the closed material webs thereby produced, with a width of 500 mm to 1500 mm, the previously longitudinally running cords are usually transversely arranged, in the case of so-called angled carcasses even at an angle other than 90°. It is customary in practice to join the end sections together by overlapping them directly on the tyre building drum. Apart from wasting material, overlapping the end sections of tyre components has adverse effects on tyre properties in normal operation, resulting in particular in imbalance and irregularity of the tyres produced. Joining the tyre components by a butt splice avoids undesired material accumulations and elongations and is consequently accompanied by an improvement in the regularity of the tyres. However, finding a reliable way of closing the tyre component in an annular form directly on the tyre building drum, in particular also in the case of angled carcasses, has proven to be scarcely feasible.

Methods and apparatuses concerned with carrying out the actual splicing operation for butt joining the end sections of material webs for tyre components are known from the patent literature. For example, DE 23 59 131 A discloses an apparatus for joining the edges of the end sections of a material web in which two pairs of clamping jaws that can be moved in relation to one another are provided, said jaws being slidably movable in a special way to allow a firm join to be produced between the edges of the end sections without adverse effects.

DE 101 56 472 A concerns a method for butt splicing with the aid of a splicing device which has a pair of jaws respectively above and below a splicing support, the jaws of each pair of jaws being horizontally movable towards and away from one another and the pairs of jaws altogether being movable vertically towards and away from one another. The vertical movement of the pairs of jaws is in this case performed independently of the horizontal movement of the individual jaws, whereby the splicing operation can proceed more quickly.

In the preparation of the material, known methods can be carried out comparatively easily, since it is possible to work on the level. However, it is desired also to incorporate methods and apparatuses for the butt splicing of tyre components in an automated production process in order to be able to carry out tyre production as a whole in an automated and efficient manner.

The invention is based on the object of providing a method and an apparatus that assist or allow an automated production process.

As far as the method is concerned, the set object is achieved according to the invention by one end section of the cut-to-length material web coming from a servicer device being laid and fixed on a splicing element of one pair of splicing elements, by a base part that supports this pair of splicing elements being rotated through 360°, while the material web is simultaneously supplied, until the second end section of the then annularly formed material web is positioned and fixed at a small distance from the first-mentioned end section and in the same plane as the latter on the second splicing element of this pair of splicing elements,

subsequently, the second pair of splicing elements being vertically moved into place and positioned and fixed on the end sections

and a butt splice being carried out by moving the pairs of upper and lower splicing elements horizontally together.

According to a preferred embodiment of the method, the base part together with its pair of splicing elements is subsequently moved out from the then annularly closed material web, the material web being held on the other pair of splicing elements, a transfer unit is moved into the annularly closed material web and deforms the material web in such a way that it assumes a circular cross section, the material web subsequently being positioned on a transfer device for transporting to a tyre building drum.

As far as the apparatus is concerned, the set object is achieved according to the invention by the splicing device having a rotatable base part, on which one of the pairs of splicing elements is arranged.

The method according to the invention therefore allows fully automatic execution of the individual steps of producing a butt splice, beginning with the laying of the end sections of the material web to be spliced and ending with the transfer of the finished spliced tyre component onto the transfer device to the tyre building drum. The method according to the invention and the apparatus according to the invention are also very well suited for the splicing of material webs to produce so-called angled carcasses.

The apparatus allows automatic laying of the end sections of the material web on one of the pairs of splicing elements.

It is important that the end sections of the material web hold well on the splicing elements. This can be ensured by corresponding suction devices (vacuum suckers); in the case of material webs that comprise steel cords, it may also be envisaged to hold the end sections electromagnetically.

The transfer unit by means of which the spliced material web is deformed in such a way that it assumes a circular cross section may have segments that can be moved in such a way that the inner side of the material web undergoes a deformation into a circular cross section. The segments of the transfer unit according to the invention are therefore movable at least in a radial direction. With preference, the segments can be moved as desired in a plane normal to their longitudinal extent by means of linear drives.

Further features, advantages and details of the invention are now described more specifically on the basis of the drawing, which schematically represents exemplary embodiments and in which:

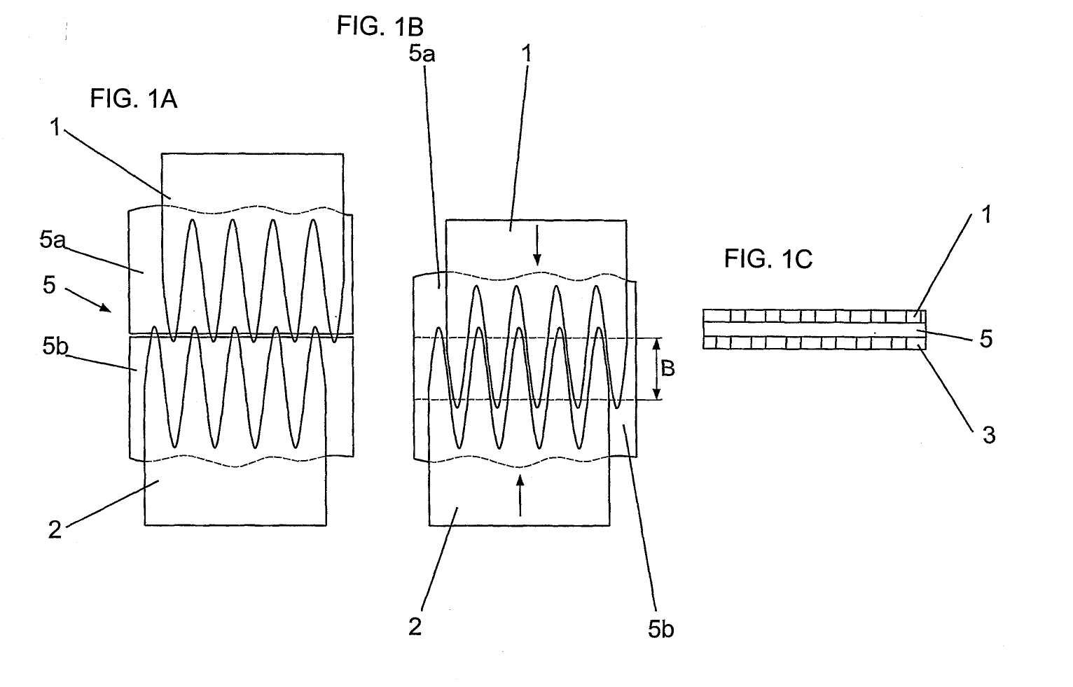

FIGS. 1a, 1b and 1c show by schematic views the configuration and mode of operation of clamping strips for producing a butt splice and

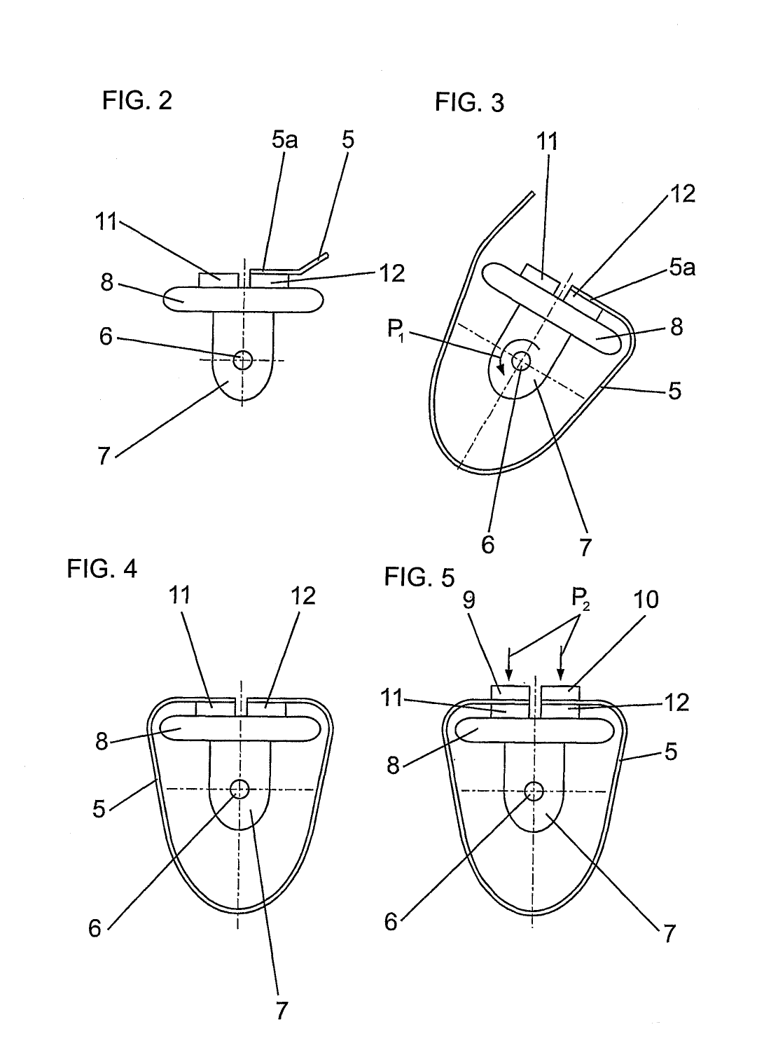

FIG. 2 to FIG. 10 show individual method steps of handling a cut-to-length material web that is butt-spliced and subsequently transported to a tyre building drum.

FIG. 1a and FIG. 1b show in plan view the two end sections 5a, 5b of an already cut-to-length material web 5, which for example comprises rubber-coated textile or steel cords and is intended for the production of a carcass insert of a pneumatic vehicle tyre. The end sections 5a, 5b are joined together in one plane by a butt joint, so that the material web 5 is brought into the form of a ring. FIG. 1a shows the mutual position of the end faces of the end sections 5a, 5b immediately before the splicing operation, which is carried out by means of two pairs of toothed clamping strips 1, 2 and 3, 4, which are component parts of splicing elements. The pair of clamping strips 1, 2 takes hold of or lies on the upper side of the end sections 5a, 5b, the pair of clamping strips 3, 4 comes into contact with the underside of the end sections 5a, 5b. The pair of clamping strips shown in FIGS. 1a and 1b may optionally be the pair 1, 2 or the pair 3, 4. The mutually facing end sections of each pair of clamping strips 1, 2 and 3, 4 are provided with a pronounced toothing, the teeth being arranged in relation to one another, as shown in FIG. 1a, in such a way that the two upper clamping strips 1, 2 and equally the two lower clamping strips 3, 4 can be pushed slightly into one another with mutual engagement of the teeth. FIG. 1b shows one of the pairs of clamping strips 1, 2 or 3, 4 in the position in which they are pushed into one another, while the other pair of clamping strips is at the same time equally pushed together. Moving the upper clamping strips 1, 2 together and the two lower clamping strips 3, 4 together has the effect that the cut faces at the ends of the two end sections 5a, 5b of the material web 5 are pressed firmly against one another. The toothed clamping strips 1, 2 and 3, 4 ensure the splicing of the end sections of a material web that holds well in the plane.

The apparatus shown in FIGS. 2 to 7 is provided with a splicing device, by means of which the end sections 5a, 5b of a material web 5 are spliced with a butt joint in the plane, preferably using splicing elements with toothed clamping strips as described above. A central component part of the apparatus is the base part 7 shown in FIG. 2 to FIG. 7, which is mounted rotatably at an axis of rotation 6. On the base part 7 there is a splicing table 8, which is a component part of the splicing device, which has a pair of upper splicing elements 9 and 10 and a pair of lower splicing elements 11, 12, the splicing elements 9, 10 and the splicing elements 11, 12 being movable towards one another and away from one another.

FIG. 2 shows the starting position of the apparatus, in which, the one end section 5a of the cut-to-length material web 5 to be spliced, which is supplied by means of a servicer device, for example a transporting belt has already been laid on the lower splicing element 12, on the right in this figure of the drawing. The end section 5a is firmly held on the splicing element 12, for example by suction using vacuum suckers that are not shown. In the case of splicing devices that splice material webs provided with steel cords, firm holding on the splicing elements may also be performed electromagnetically.

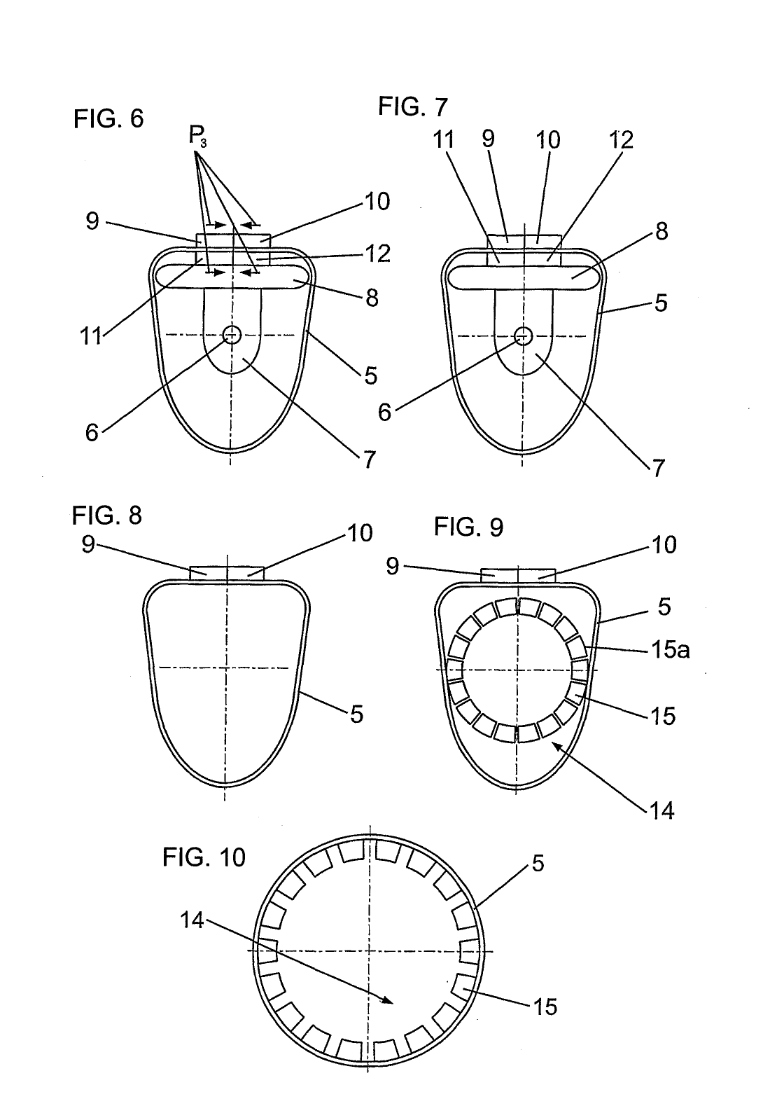

With the end section 5a laid on and held, the base part 7 is set in rotation (see arrow P₁ in FIG. 3) in such a way that the continuously supplied material web 5 is guided around the base part 7 until its second end section 5b is laid on the other, lower splicing element 11 and is fixed, for example likewise by means of vacuum suckers. FIGS. 3 and 4 show these method steps; in FIG. 4, the two end sections 5a, 5b of the material web 5 have been laid on and fixed. In the next step, the two upper splicing elements 9, 10 are positioned from above (by moving in the vertical direction) on the end sections 5a, 5b of the material web 5 (see arrow P₂ in FIG. 3), and the splicing elements 9, 10 and the splicing elements 11, 12 are pressed against one another, so that the two end sections 5a, 5b are securely held between the splicing elements 9, 10, 11, 12 (see FIG. 5). In the next method step, the actual splicing operation is performed, by the upper and lower splicing elements 9, 10 and 11, 12 being moved towards one another simultaneously (by moving in the horizontal direction) (see arrow P₃ in FIG. 6) and the end faces of the end sections 5a, 5b of the material web 5 being pressed onto one another, the toothings (not represented) of clamping strips located on the splicing elements 9, 10, 11, 12 engaging in one another as described above. The end portions 5a, 5b of the spliced material web 5 are subsequently fixed on the upper splicing elements 9, 10, for example by means of vacuum suckers; the lower splicing elements 11, 12 are released and, together with the base part 7, are moved out of the spliced material web 5. FIG. 8 shows the annularly closed material web 5 suspended from the upper splicing elements 9, 10 and having an elongated cross section, deviating from a circular form, as a result of its own weight. In the next step, a transfer unit 14 is moved into the interior of the material web 5 (see FIG. 9). The transfer unit 14 has a multiplicity of elongate segments 15, which extend over the depth of the annular material web. The segments 15 are movable by means of suitable drives, for example linear drives, in one plane transversely to their longitudinal extent, so that they can be brought up to the inner side of the annular material web 5 until their outer sides 15a come into contact with the latter. With the transfer unit 15 moved in, the upper splicing elements 9, 10 are released from the material web 5 and moved away.

The segments 15 of the transfer unit 14 are then moved in such a way and for such a time that the cross-sectionally elongate material web 5 is brought into a cross-sectional form with a circular cross section. FIG. 10 shows this position; the outer surfaces of the segments 15 lie against the inner side of the material web 5, which is now circular in cross section. Now the material web 5 can pass on to one of the customary transfer devices, be transported to the tyre building drum and be positioned as a tyre component in the corresponding method step.

All the procedures in the method are carried out in an automated manner; a correspondingly programmed control of the entire installation with all the interacting components is envisaged.

The apparatus may also be configured in such a way that the end sections of the material web to be spliced are first positioned on the upper splicing elements. It is also pointed out that, in the case of the apparatus according to the invention, a butt splice of the end sections of a material web can also be carried out in some way other than that shown in FIGS. 1a to 1c.

In an alternative configuration of the transfer unit 14, it may have segments that are arranged in principle in a circular form, which are merely movable in a radial direction.

1-8. (canceled)

9. A method for the automated construction of a pneumatic vehicle tire, the method which comprises:
providing a splicing device with pairs of upper and lower splicing elements movably disposed relative to one another and a rotatably mounted base part carrying a first pair of the splicing elements;
laying and fixing a first end section of a cut-to-length material web on a first splicing element of the first pair of splicing elements;
rotating the base part supporting the first pair of splicing elements through 360° while supplying the material web and forming the material web into an annular shape, until a second end section of the material web is positioned and fixed at a small spacing distance from the first end section and substantially coplanar with the first end section on a second splicing element of the first pair of splicing elements;
subsequently moving a second pair of splicing elements vertically and positioning and fixing the second pair of splicing elements on the first and second end sections of the material web; and
forming a butt splice by moving the pairs of upper and lower splicing elements horizontally together to form a carcass insert of the vehicle tire.

10. The method according to claim 9, wherein the material web are textile cords or steel cords embedded in a rubber mixture.

11. The method according to claim 9, which further comprises, subsequently to the step of forming a butt splice:
removing the base part together with the first pair of splicing elements out from the annularly closed material web, while holding the material web on the second pair of splicing elements;
moving a transfer unit into the annularly closed material web;
deforming the material web to assume a circular cross section, and subsequently positioning the material web on a transfer device for transporting to a tire building drum.

12. The method according to claim 9, which comprises holding the first and second end sections of the material web on the splicing elements by way of suction devices.

13. The method according to claim 9, wherein the material web is formed of steel cords embedded in a rubber mixture, and the method comprises holding the first and second end sections of the material web on the splicing elements electromagnetically.

14. The method according to claim 9, which comprises providing the spliced, cross-sectionally elongate material web with a circular cross section by way of correspondingly movable segments of a transfer unit.

15. An apparatus configured for the automated construction of a pneumatic vehicle tire using butt spliced tire components consisting of material webs to produce a carcass insert of the vehicle tire, the apparatus comprising:
a splicing device including pairs of upper and lower splicing elements disposed to be moved relative to one another and configured to clamp therein end sections of cut-to-length material webs to be spliced;
a rotatable base part carrying one of said pairs of splicing elements for rotation thereof with an end section of the material web clamped therein.

16. The apparatus according to claim 14, wherein the material web are textile cords or steel cords embedded in a rubber mixture.

17. A transfer unit, comprising:
a multiplicity of annularly arranged, elongated segments, that are movable at least in a radial direction; and
configured for use in the method according to claim 11.

18. The transfer unit according to claim 16, wherein said segments are freely movable in a plane normal to a longitudinal extent thereof by way of linear drives.
